(19) United States
(12) Patent Application Publication
(10) Pub. No.: US 2006/0108821 A1
(43) Pub. Date: May 25, 2006

(54) Long gate

(76) Inventors: Roy Hawkins, Chatsworth, GA (US); Jay Harris Hawkins, Chatsworth, GA (US); Harry Lynn Hawkins, Chatsworth, GA (US)

Correspondence Address: DEVELOPMENT MANAGEMENT SPECIALIST, INC., 119 BROWN BRIDGE ROAD, CHATSWORTH, GA, 30705, US

(21) Appl. No.: 11/159,675

(22) Filed: Sep. 15, 2005

Related U.S. Application Data
(60) Provisional application No. 60/629,246, filed on Nov. 19, 2004.

(51) Int. Cl. B62D 33/00

(52) U.S. Cl. 296/57.1

(57) ABSTRACT

The present invention relates to a pick-up and the ability to make the modern short bed pick-up trucks more versatile for carrying long items. The present invention will allow the pick-up owner to have a vehicle that looks just like a regular truck, but with the ability to extend the hauling capacity up to 4′-0″ in length. The “long” gate will extend out on slide supports and lock into place. When finished hauling long items, simply release the lock and the tail gate will slide back into the normal position.

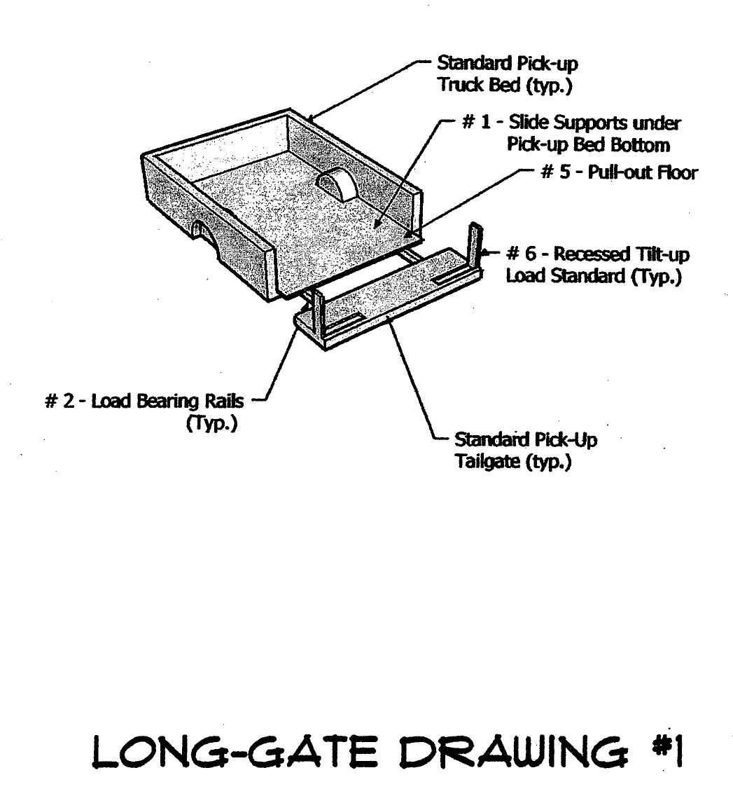

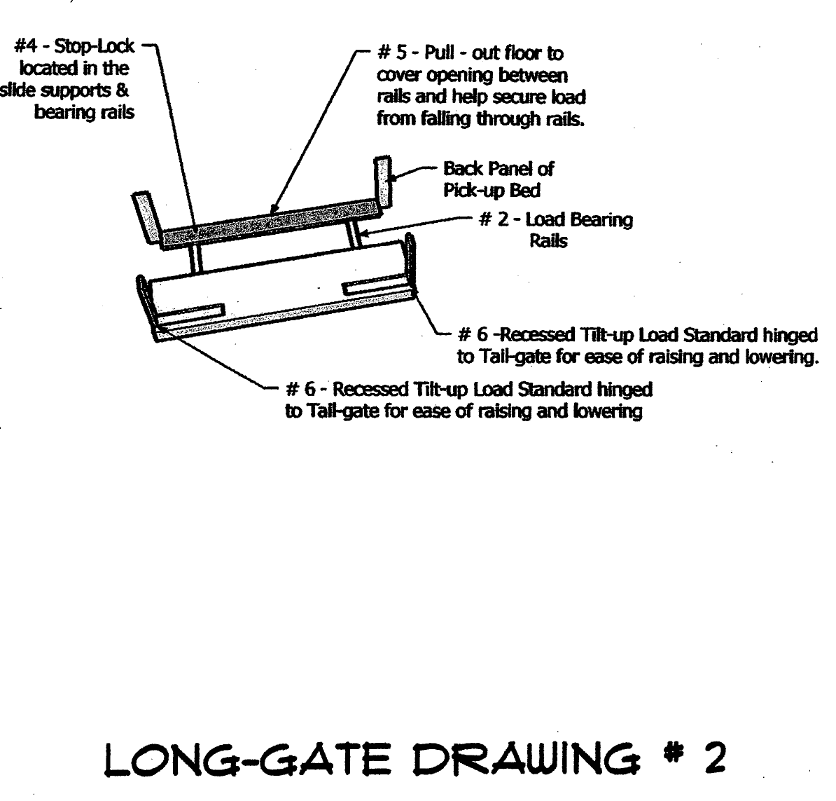

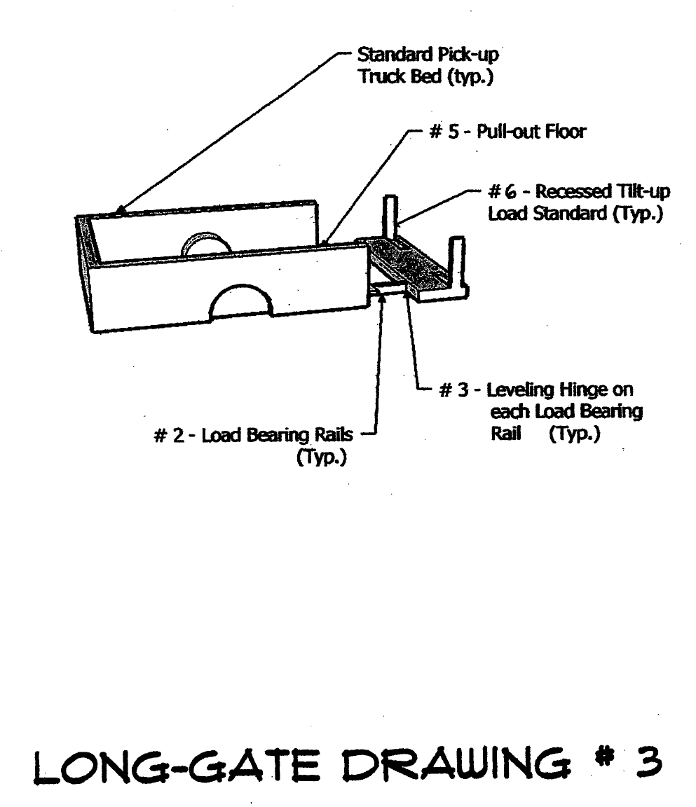

### CROSS REFERENCE TO RELATED APPLICATIONS

Patent Number:
U.S. Pat. No. 6,113,173—Truck Bed Extender
U.S. Pat. No. 6,113,171—Tailgate Extender
U.S. Pat. No. 5,941,588—Tailgate extend-a-bed kit
U.S. Pat. No. 5,775,759—Vehicle Bed Extender
U.S. Pat. No. 5,732,995—Tailgate Extender
U.S. Pat. No. 5,700,047—Truck Bed Extender
U.S. Pat. No. 4,932,703—Truck Bed Extender

### DESCRIPTION OF DRAWING

The present invention will make pick-up trucks more versatile by extending the tailgate, with-out altering the look of the tail gate when closed. The modern short bed trucks will have an option for hauling long loads.

Two slide supports (#1) will be installed beneath the truck bed and extend to the back of the bed. These slide supports (#1) will contain the two load bearing rails (#2) which will attach to the tailgate with two leveling hinges (#3). Also there will be a spring-loaded latch to stop pullout distances. The stop lock (#4) will unlock when pushed back into normal tailgate position. The opening created by the extension of the two rails will be covered by a pull-out floor (#5) that pulls from a pocket in the existing bottom of the pick-up bed. The Tailgate will also have two recessed standards (#6) that can be tilted up to provide load security and tie downs.

This invention will allow truck owners to add approximately 4′-0″ to the length of their pick-up truck beds. However, the invention will allow the short-bed look when not in use.

1. Long Gate is the first innovative way to make the ever popular pick-up truck more versatile
without making drastic design changes to the existing truck bed. Yet this is the most radical change that the truck bed has experienced in the history of pick-up truck production. The idea of making the tail-gate extendable solves many hauling problems for today's truck owners (i.e. contractors, farmers, ranchers, etc.) Long-gate can be successfully added to all types of today's pick-up trucks regardless of make or style. The existing bed length does not come into play either. In conclusion, Long-gate will take the pick-up tuck industry to the next level by providing a larger cargo area at a fraction of the cost compared to permanently extending the bed.
